(19) United States
(12) Patent Application Publication
(10) Pub. No.: US 2026/0336246 A1
(43) Pub. Date: Oct. 29, 2026

(54) ALIGNMENT MODULE FOR IRREGULAR EDGES

(71) Applicant: BOBST MEX SA, Mex (CH)

(72) Inventors: Bryan CARDOSO, Pully (CH); Olivier FAVRE, Bussigny (CH)

(73) Assignee: BOBST MEX SA, Mex (CH)

(21) Appl. No.: 19/106,344

(22) PCT Filed: Aug. 28, 2023
(86) PCT No.: PCT/EP2023/073519

§ 371 Date: Feb. 25, 2025

(30) Foreign Application Priority Data
Sep. 1, 2022 (EP) 22193522.4

(51) Int. Cl. B31B 50/04

(52) U.S. Cl. CPC B31B 50/044; B31B 50/042

(57) ABSTRACT

The present invention relates to an alignment module (11) for a converting machine (1). The alignment module comprises an alignment device (30) having an upper pressing member (22), a lower conveyor (24) and a guide (26). The guide is further provided with a downwardly sloping inlet end (32), the inlet end being configured to direct a lateral portion of the blank under the guide, while contacting the lateral guiding surface (40) with an internal segment edge (S1, S2) of the blank, the internal segment edge being arranged closer to the central longitudinal axis of the blank than the lateral portion of the blank positioned under the guide.

### FIELD OF THE INVENTION

The present invention relates to a converting machine for producing paper and cardboard containers, such as folding boxes. In particular, the invention relates to an alignment module configured to laterally align blanks with irregular lateral edges.

### BACKGROUND

Converting machines such as folder-gluers are used in the production of paperboard and cardboard boxes. These machines are configured to receive cut-to-shaped blanks and then fold and glue them to form folding boxes or other similar packaging containers. The blanks are provided with cut lines which define the overall shape of the blanks and crease lines which define the locations of folds.

In order to ensure that folding is effectuated at the location defined by the crease lines, the folder-gluer machine comprises an alignment module located upstream of a folding module. The alignment module is configured to laterally align the blanks. An example of an alignment module is described in document U.S. Pat. No. 7,398,872.

The alignment module in U.S. Pat. No. 7,398,872 comprises an upper pressing member and a lower conveyor configured to receive and convey the blanks in a clearance therebetween. The blank is conveyed with one lateral edge urged against a lateral guide extending in a direction of transportation of the blank. In such a way, the blank is laterally aligned in the converting machine.

Depending on the geometry of the blanks, the alignment module can be configured to align against a left side or a right side of the blank. Typically, a straight or a uniform lateral edge is more advantageous for aligning against the guide than an irregular lateral edge. However, for some blanks both the left and right lateral edges are irregular. Such types of blanks are designed to form crash lock boxes, wallet type packaging, hand erected boxes, etc. These boxes may also be provided with adhesive stripes.

Consequently, these types of blanks are difficult to align in the direction of transportation and there is a risk of causing a rotation of the blanks during the transportation in the alignment module.

### SUMMARY

In view of the prior art, it is an object of the present invention to improve the alignment of blanks provided with irregular lateral edges.

This object is solved by an alignment module according to claim 1.

According to a first aspect of the present invention, there is provided an alignment module for a converting machine, the alignment module being configured to correct a lateral position of a blank conveyed in a direction of transportation through the converting machine. The blank comprises a first lateral peripheral edge and a second lateral peripheral edge, the first and second lateral peripheral edges being arranged at opposite sides of a central longitudinal axis of the blank and extending in the direction of transportation. The alignment module comprises at least one alignment device having an upper pressing member, a lower conveyor and a guide, and wherein the upper pressing member and lower conveyor are configured to receive and transport the blank in a clearance therebetween, and wherein the guide is an elongated bar provided with a lateral guiding surface and is extending in the direction of transportation.

The guide is further provided with a downwardly sloping inlet end, the inlet end being configured to direct a lateral portion of the blank under the guide, while contacting the lateral guiding surface with an internal segment edge of the blank, the internal segment edge being arranged closer to the central longitudinal axis of the blank than the lateral portion of the blank positioned under the guide. The downwardly sloping inlet end has a wedge shape.

The first and second lateral peripheral edges are irregular and may each comprise a plurality of segment edges extending in the direction of transportation and arranged at different lateral positions from the central longitudinal axis of the blank. The term “irregular edges” means edges which are not straight.

Each peripheral lateral edge comprises one distal segment edge and at least one internal segment edge, the internal segment edge being positioned closer to central longitudinal axis of the blank than the distal segment edge.

The guide is positioned laterally of the upper pressing member and the conveyor belt.

The invention is based on a realization that an irregular lateral edge comprises a plurality of different segment edges arranged at different lateral positions. The position and length of some internal segment edges make them more advantageous to align against than the segment edge positioned most distal in the lateral direction, i.e. the distal lateral edge. The lateral direction is defined as perpendicular to the direction of transportation of the blank. By providing a guide with a downwardly inclined inlet portion that forces the extremity of the blank under it, an internal lateral segment edge can be accessed by the alignment surface of the guide.

According to an embodiment, the lower conveyor is positioned such that the lateral portion of the blank is unsupported by the lower conveyor.

In such a way, the edge is unsupported and directed downwards under the alignment guide with the help of gravity.

In an embodiment, the alignment guide is provided with a groove, and wherein the groove is configured to retain the guiding edge of the blank. The guiding edge is an internal edge in the blank.

In an embodiment, the alignment module comprises an inlet portion in which the upper pressing member is arranged at a distance from the lower conveyor, and wherein the downwardly sloping inlet end of the guide is located in the inlet portion.

The alignment guide may be laterally displaceable.

In an embodiment, the upper alignment module further comprises a slider and wherein the connection axis of the slider and the connection axis of the guide rail coincide.

According to a second aspect of the present invention, there is provided a converting machine comprising an alignment module according to the first aspect of the present invention, and wherein the converting machine further comprises a folding module, and a blank turning module configured to rotate the blanks 90°. The converting machine comprises a second alignment module which is arranged between the blank turning module and the folding module.

The blank turning module and the second alignment module may be separate modules which are mounted on two separate chassis. Alternatively, the blank turning module and the second alignment module may be a combined module having a single chassis.

### BRIEF DESCRIPTION OF THE DRAWINGS

The invention will now be described with reference to the appended drawings, in which like features are denoted with the same reference numbers and in which:

FIG. 1 is a schematic view of a converting machine in the configuration of a folder gluer;

FIGS. 2a and 2b are a schematic perspective view of a folding box and a planar view of a blank, respectively;

FIG. 3 is schematic perspective view of an alignment module according to an embodiment of the present invention;

FIG. 4 is schematic cross-sectional view of the alignment module in FIG. 3 and a feeder module;

FIG. 5a is a detailed planar view of an inlet portion of an alignment module according to an embodiment of the present invention;

FIG. 5b is a cross sectional view of the inlet portion of FIG. 5a; and

FIG. 6 is a cross sectional view of the inlet portion of FIG. 5b with a blank 2; and

FIG. 7 is a top view of a feeder module and an alignment module according to an embodiment of the present invention.

### DETAILED DESCRIPTION

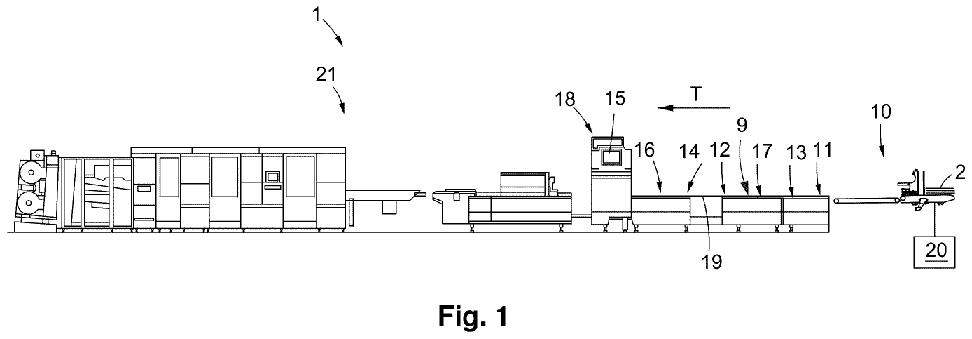

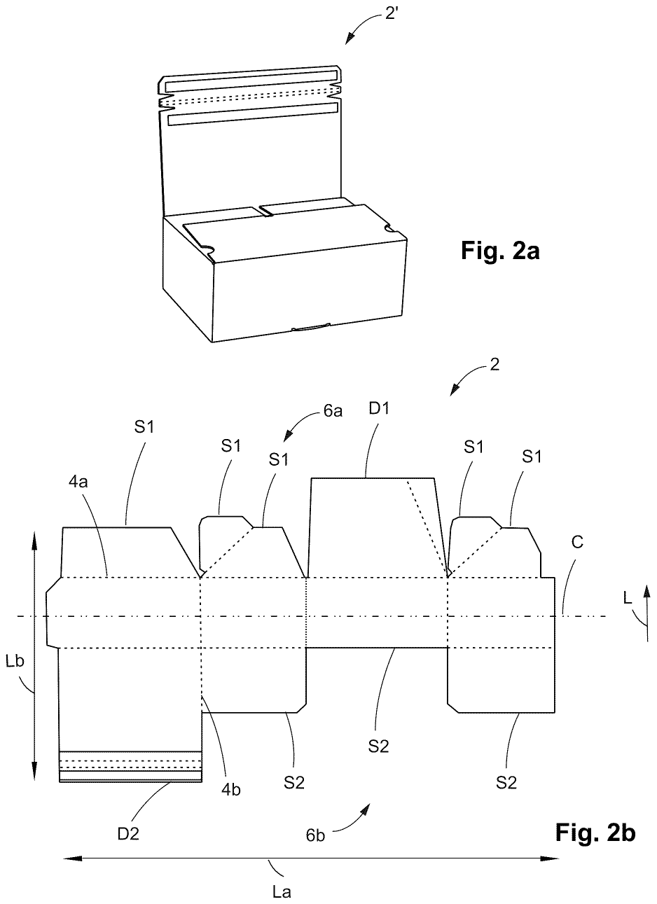

Referring to the figures and in particular to FIGS. 1, 2a and 2b. The folder-gluer machine 1 is configured to receive a cut-to-shaped blank 2 as illustrated in FIG. 2b, and then fold and glue the blank 2 to form a folding box 2′ or other folded and glued packaging containers 2′.

As illustrated in FIG. 1, the present folder-gluer machine 1 may comprise a series of different workstations in the form of modules. The modules may include, from an inlet to an outlet and in a direction of transportation T: a feeder module 10, an alignment module 11, a fold pre-breaking module 12, a gluing module 14 and a folding module 16. The folder-gluer machine 1 may further comprise a main user interface 15 and a quality control system 18.

The alignment module 11 is arranged downstream in the direction of transportation T of the feeder module 10 and is configured to laterally align the blank 2 to a predefined lateral position. The predetermined lateral position is defined by the position of the longitudinal crease lines 4 and the position of folding and auxiliary tools in the converting machine 1. The alignment module 11 is thus configured to align the blank 2 in a direction perpendicular to the direction of transportation T.

Between the alignment module 11 and the fold pre-breaking module 12, an auxiliary module in the form of a glue strip module 13 and a blank turning module 17 may be located. The glue strip module is configured to apply a glue strip (i.e., an adhesive line) and a protective cover such that the glue strip can be used when re-sealing the box after a first use. Such a glue strip module is provided by the company Enpro, such as their “SPA 3.0—Silicone Paper Applicator”. The blank turning module 17 is configured to rotate the blanks 90 degrees before the blank 2 enters the folding module 16. An example of a blank turning module is described in EP3038954.

Preferably, a second alignment module 9 is arranged between the blank turning module 17 and the folding module 16. The blank turning module 17 and the second alignment module 9 may be separate modules which are mounted on two separate chassis. Alternatively, the blank turning module 17 and the second alignment module 9 may be a combined module having a single chassis.

After the gluing module 14 and the folding module 16, a delivery module and conditioning section 21 can be provided in order to count and separate a shingled stream of folding boxes 2′ into separate batches.

The converting machine 1 further comprises a conveyance system 19 comprising conveyors such as endless belts and rollers configured to transport the blanks 2 in the direction of transportation T. The converting machine 1 also comprises a central control circuitry 20 configured to control the operation of the converting machine 1.

To enable folding, the blank 2 is provided with crease lines 4. A first group of crease lines 4a extend in the direction of transportation T of the blank 2 in the alignment module 11. The first group of crease lines 4a also extend in the direction of transportation T of the blank 2 in the feeder module 10.

A second group of crease lines 4b are arranged perpendicular to the first group of crease lines 4a. If a blank turning module 17 is used, the second group of crease lines 4b extend in the direction of transportation T of the blank in the folding module 16.

The blank 2 has a longitudinal length La in the direction of transportation T in the alignment module 11. Similarly, if a blank turning module 17 is used, the blank 2 has a longitudinal length Lb in the direction of transportation T in the folding module 16. For blanks 2 with irregular front edges and irregular rear edges, the longitudinal lengths La, Lb is the maximum length of the blank 2 in the direction of transportation T.

In the alignment module 11, the blank 2 is provided with a first peripheral lateral edge 6a and a second peripheral lateral edge 6b. The first and second peripheral lateral edges 6a, 6b may be irregular. The peripheral lateral edges 6a, 6b allow the formation of flaps and folding faces.

The first peripheral lateral edge 6a is provided with a plurality of segment edges S1 positioned at different lateral positions in relation to a central longitudinal axis C of the blank 2. The central longitudinal axis C coincides with the direction of transportation in the alignment module 11. Preferably, the central longitudinal axis C is arranged at the center of the blank 2. Similarly, the second peripheral lateral edge 6b is provided with a plurality of segment edges S2 positioned at different lateral positions in relation to the central longitudinal axis C of the blank 2. Depending on the type of packaging container 2′ and the shape of the blank 2, the number of segment edges S1, S2 may differ. The lateral positions are defined as distances in the lateral direction L, which is defined as a direction perpendicular to the direction of transportation T of the blank 2 in the alignment module. Hence, the lateral direction L, may also be is defined as a direction perpendicular to the direction of transportation T of the blank 2 in the feeder module 10.

Each peripheral lateral edge 6a, 6b comprises one distal segment edge D1, D2 and at least one internal segment edge S1, S2. The at least one internal segment edge S1, S2 is positioned closer to the central longitudinal axis C of the blank 2 than the distal segment edge D1, D2. The distal segment edges D1, D2 are located at the lateral extremities of the blank 2 in the alignment module 11.

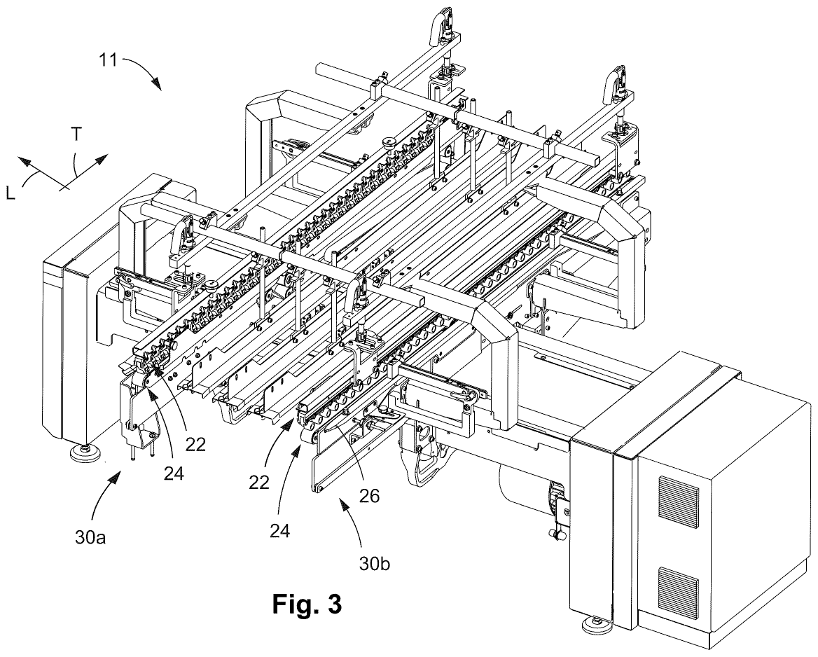

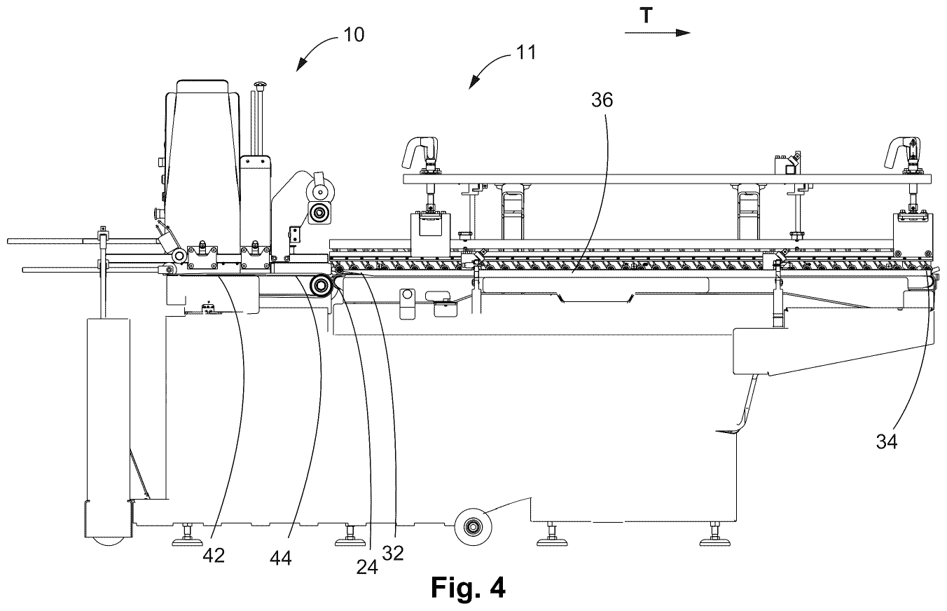

As illustrated in FIG. 3, the alignment module 11 preferably comprises a first alignment device 30a and a second alignment device 30b. The first alignment device 30a is configured to abut against a left side of the blank 2 and the second alignment device 30b is configured to abut against a right side of the blank 2.

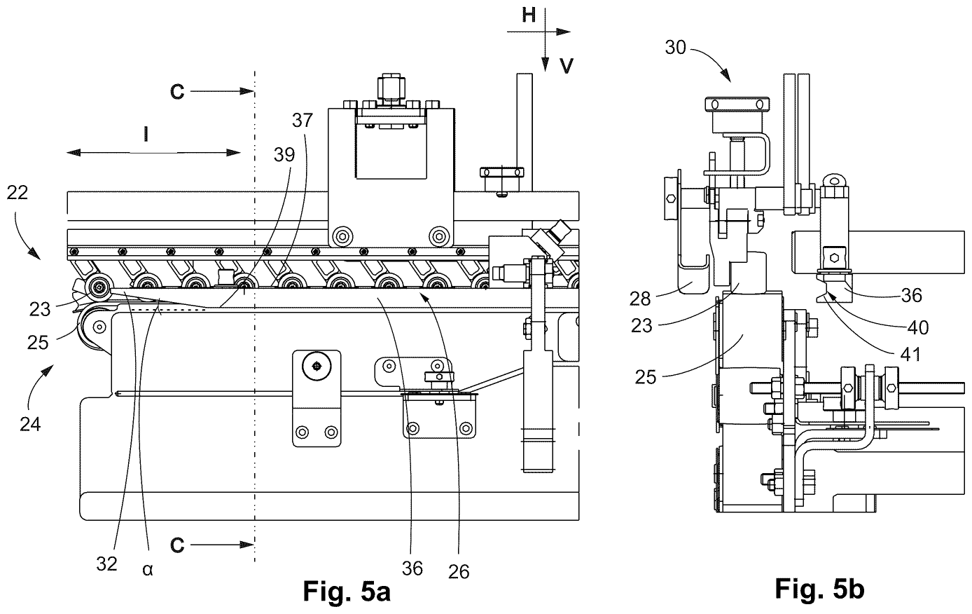

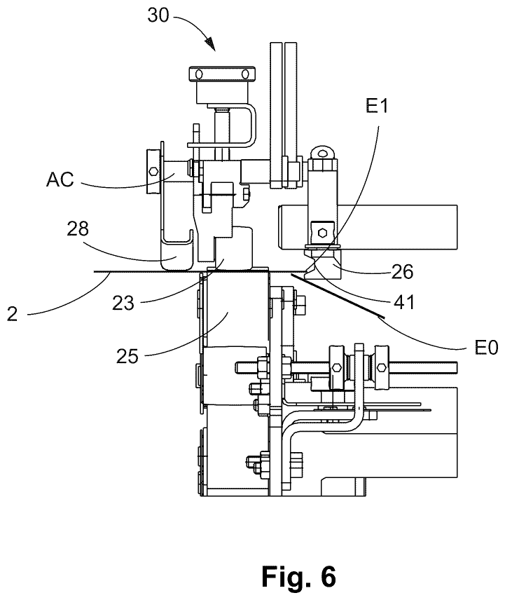

As best seen in FIG. 5a, the alignment devices 30a, 30b comprise an upper pressing member 22 provided with a plurality of pressing rollers 23 arranged in a line, an alignment conveyor 24 and a guide 26.

The alignment module 11 is configured to receive the blank 2 in a clearance between the upper pressing member 22 and the alignment conveyor 24. The upper pressing member 22 and the alignment conveyor 24 are arranged at an angle in the direction of transportation T such as to direct a lateral edge 6a, 6b of the blanks 2 against the guide 26. The guide 26 is arranged with its longitudinal extension coinciding with the direction of transportation T.

The alignment conveyor 24 comprises an endless conveyor belt 25 and is configured to be in contact and drive the blank 2 forward in the direction of transportation T. The pressing rollers 23 may be idle.

The first and second alignment devices 30a, 30b are not used at the same time. Instead, they provide the option to select which lateral edge 6a, 6b of the blank 2 to align against the guide 26.

When one of the alignment devices 30a, 30b is activated, the other one is deactivated. In the deactivated alignment device 30a, 30b, the pressing rollers 23 may be moved upwards and away from the blank 2 such that the pressing rollers 23 of the deactivated alignment device 30a, 30b are not in contact with the blank 2.

As illustrated in FIG. 5a, the alignment module 11 may comprise an inlet section I. The inlet section I provides a distance over which the blanks 2 are not guided. This can be achieved by arranging at least some of the pressing rollers 23 such that they are arranged at a distance from the alignment conveyor 24. In such a way, the pressing member 22 does not grasp the blank 2 and the trajectory of the blank 2 in the inlet section I is not modified by the alignment device 30.

The length of the inlet section I can be configured such that the blank 2 will only be moved laterally when the entire longitudinal length La of the blank 2 is in the alignment module 11. This allows the alignment module 11 to receive the full longitudinal length La of the blank 2 before moving the blank 2 sideways. This also allows the blanks 2 to exit from the feeder module 10 before modifying their trajectory.

The side of alignment is selected based on the geometries of the peripheral lateral edges 6a, 6b of the blank 2. The choice between the right side and the left side alignment can be selected manually by the operator by inspecting the first and second peripheral lateral edges 6a,6b. Alternatively, the control unit 50 may perform a calculation to determine which peripheral lateral edge 6a, 6b is most suitable for alignment.

Ideally, a long and straight distal segment edge D1, D2 is selected as a suitable alignment edge. However, some blanks 2 as the one illustrated in FIG. 2b have irregular peripheral lateral edges 6a, 6b, and the distal segment edges D1, D2 are relatively short in the direction of transportation T. For irregular peripheral lateral edges 6a, 6b 6a, 6b, the present alignment device 11 also allows alignment against an internal segment edge S1, S2. This is advantageous when there is an internal segment edge S1, S2 which is straight (in the direction of transportation T) and provided with a significant length in the direction in the direction of transportation T in the alignment module 11. Preferably, a significant length is about 50% of the longitudinal length La.

As best seen in FIGS. 5a and 5b, the guide 26 is provided with an inlet end 32, an outlet end 34 and a longitudinal guiding portion 36. The inlet end 32 is downwardly sloping in the direction of transportation T. The guide 26 has an upper surface 37 and a lower surface 39. The upper surface 37 and the lower surface 39 preferably have an extension coinciding with the horizontal direction H, and the upper surface is arranged vertically above the lower surface in the vertical direction V. In the inlet section I, the upper surface 37 of the guide 26 extends further upstream in the direction of transportation T than the lower side 39 of the guide 26. In such a way, the guide 26 is provided with a downwardly sloping inlet end 32 of the guide 26 is configured to direct a lateral portion E0 of the blank under the guide 26.

The slope angle α can be between 20° and 40°, preferably around 30° in relation to the longitudinal extension of the guide 26. The inlet end 32 is thus provided with a wedge shape and is configured to direct a distal segment edge D1, D2 and a lateral portion E0 of the blank 2 underneath the guide 26. This allows the front leading edge of the blank 2 to be partially directed under the guide 26. The inlet end 32 of the guide 26 may be located in the inlet section I where the blank 2 is not laterally guided.

As illustrated in FIG. 5b, the longitudinal guiding portion 36 has an alignment surface 40 configured to abut against an internal segment edge S1, S2 of the blank 2. The alignment surface 40 of the guide 26 may be flat. Alternatively, as illustrated in FIG. 5b, the alignment surface 40 may be provided with a groove 41. The groove 41 is configured to receive a selected internal alignment edge S1, S2 of the blank 2.

In the inlet section I, the alignment surface 40 of the guide 26 may positioned at a lateral distance from the selected internal alignment edge S1, S2. In such a way, the guide 26 is not in contact with the guided edge on the blank 2 until the lateral portion E0 of the blank 2 is positioned under the guide 26.

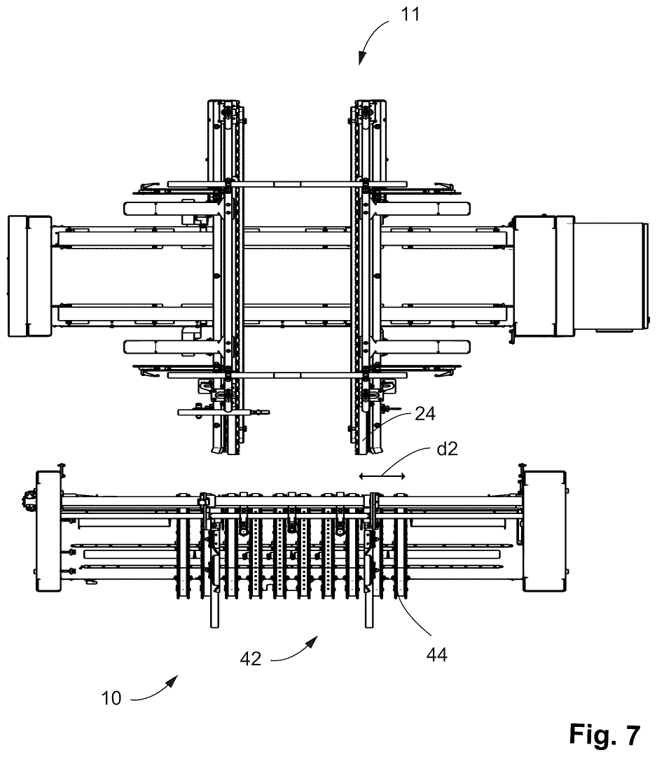

As illustrated in FIG. 7, the alignment module 11 is positioned downstream of the feeder module 10. The feeder module 10 comprises a loading surface 42 configured to receive a stack of blanks 2. The loading surface 42 comprises a plurality of drive belts 44 configured to contact and drive the lowermost blank 2 in the stack forward in the direction of transportation T.

The lower conveyor 24 is laterally positioned such that the lateral portion E0 of the blank 2 extends further in the lateral direction and is unsupported. The drive belt 44 which is the most distal and arranged at the selected guiding edge S1, S2 of the blank 2 is positioned further outwards in the lateral direction than the lower conveyor 24 in the alignment module 11.

This provides a formation of a lateral gap d2 in the transportation path. However, a central portion of the blank 2 is supported by at least one conveyor 24. The gap d2 thus provides a distance over which the distal lateral segment edge D1, D2 of the blank 2 is unsupported. The gap d2 allows the distal lateral segment edge D1, D2 to vertically descend under the influence of gravity as the blank exits from the feeder module 10. This assists the sloping inlet end 32 in directing the distal lateral segment edge D1, D2 under the guide 26.

The upper alignment module may further comprise a slider 28. The slider 28 is configured to contact and prevent a vertical movement of the blank laterally of the guide 26.

1. An alignment module for a converting machine,
the alignment module being configured to correct a lateral position of a blank conveyed in a direction of transportation through the converting machine,
the blank comprising a first lateral peripheral edge and a second lateral peripheral edge,
wherein the first lateral peripheral edge and the second lateral peripheral being arranged at opposite sides of a central longitudinal axis of the blank and extending in the direction of transportation,
wherein the alignment module comprises at least one alignment device having an upper pressing member a lower conveyor and a guide,
wherein the upper pressing member and the lower conveyor are configured to receive and transport the blank in a clearance therebetween,
wherein the guide is an elongated bar provided with a lateral guiding surface and is extending in the direction of transportation, and
wherein the guide is further provided with a downwardly sloping inlet end, the downwardly sloping inlet end being configured to direct a lateral portion of the blank under the guide, while contacting the lateral guiding surface with an internal segment edge of the blank, the internal segment edge being arranged closer to the central longitudinal axis of the blank than the lateral portion of the blank positioned under the guide.

2. The alignment module according to claim 1, wherein the lower conveyor is positioned such that the lateral portion of the blank is unsupported by the lower conveyor.

3. The alignment module according to claim 1, wherein the guide is provided with a groove and wherein the groove is configured to retain the internal segment edge of the blank.

4. The alignment module according to claim 1, wherein the alignment module comprises an inlet portion in which the upper pressing member is arranged at a distance from the lower conveyor, and wherein the downwardly sloping inlet end of the guide is located in the inlet portion.

5. The alignment module according to claim 1, wherein the guide is laterally displaceable.

6. The alignment module according to claim 1, wherein the alignment module further comprises a slider and wherein a connection axis of the slider and the connection axis of the guide coincide.

7. A converting machine comprising the alignment module according to claim 1, wherein the converting machine further comprises a folding module, and a blank turning module configured to rotate the blank 90°, and wherein a second alignment module is arranged between the blank turning module and the folding module.
